(19) United States
(12) Patent Application Publication
(10) Pub. No.: US 2008/0126018 A1
(43) Pub. Date: May 29, 2008

(54) Method for constructing object by stacking up functional feature

(76) Inventors: Bor-Tsuen Lin, Yangmei Township (TW); Ming-Ren Chang, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/507,589

(22) Filed: Aug. 22, 2006

(51) Int. Cl. G06F 17/50

(52) U.S. Cl. 703/1; 706/919

(57) ABSTRACT

The present invention discloses a method for constructing an object by stacking up functional features thereof. The present invention is also exemplified with a drawing die. Functional features and their main control parameters can be identified through functional analysis, functional decomposition and geometric analysis. In the present invention, a design knowledge base, a functional feature library, a functional feature module and a graphic user interface can be utilized optionally. Moreover, the present invention can be implemented on the Windows XP system through a commercial CAD software and an API.

### BACKGROUND OF THE INVENTION

1. Field of the Invention

The present invention relates to a method for constructing an object, and particularly to a method for constructing an object by stacking up functional features of the object.

2. Related Prior Arts

To accurately design an object, the traditional two-dimensioned (2D) computer aided design (CAD) systems are no more enough because of problems such as identification and long execution time. Instead of the 2D system, three-dimensioned (3D) CAD systems capable of realizing the object with a solid model are widely applied to personal computers.

Currently, the 3D systems can construct a model merely in accordance with geometric parameters input by the designers, and couldn't provide additional knowledge for the users. Therefore, some people try to associate 3D models with a design knowledge base in a system, for example,

a) C. S. Im et al. provide a system for cold-former forging process design of a ball joint by associating a forging simulator with a CAD software;

b) L. Kong et al. provide a system for designing a plastic injection mold on window NT interfacing through Visual C++ with Solidworks software and API; and

c) S. Myung and S. Han provide a system associating a commercialized expert system shell., a design knowledge base, and a CAD software with an API program for the parametric modeling process design of machine tool.

As demand for sheet metal used in manufacturing car, aerospace and 3C industries is increased, technologies related to the stamping dies are more important now. The stamping dies can be classified into drawing dies, trimming dies and bending dies. To manufacture dies of high quality with lower cost, the CAD systems have to be applied to designing.

So far, software used for constructing the stamping die includes CADCEUS which emphasizes designing die layout and auto-processing of the die face, and “add-on” software based on CATIA such as VAMOS® which designs a die by combining preset blocks as a whole model. However, these systems are not efficient enough as only a few functions are extended to automatic design.

### SUMMARY OF THE INVENTION

The present invention relates to a method for constructing an object, which builds a model by stacking up functional features of the object. The design method of this invention is more efficient, elastic and accurate than the conventional.

In a preferred embodiment, a drawing die is exemplified. By means of functional analysis, functional decomposition and geometric analysis, functional features and their control parameters are determined as basic elements.

In this embodiment, the drawing die is designed with a construction system which includes a knowledge base for constructing a die, a functional feature library, a functional feature module and a graphic user interface. Further, a commercial CAD software, CATIA, and an application programming interface (API) are associated with a langue, VB 6, so as to implement the process on the Windows XP platform and achieve the construction system.

In this embodiment, a user can select sorts and types of the desired functional features from a drop-down menu via a graphic user interface, and then determine approximate positions of the functional features. According to the above parameters and design tables, design formulas and design criteria built in the design knowledge base, the system can determine positions and dimensions of the functional features and thus construct a model. The system can also check the construction result.

### BRIEF DESCRIPTION OF THE DRAWINGS

FIG. 1 shows the structure of the lower die.

FIG. 2a shows the process for designing a U-groove based on form feature.

FIG. 2b shows the process for designing a U-groove based on functional feature.

FIG. 3 shows the reasoning process for building the functional feature library.

FIG. 4 shows the function tree for designing the drawing die.

FIG. 5 shows functional decomposition of the drawing die.

FIG. 6a shows the geometrical outline of the U-groove.

FIG. 6b shows 2D draft of the U-groove.

FIG. 7 shows the implementation process of the construction system for designing the die by stacking up functional features thereof.

FIG. 8 indicates design standards of the U-groove.

FIG. 9 shows the Excel worksheet including data converted from the standard.

FIG. 10 indicates codes of the module for establishing functional features of the U-groove.

FIG. 11 shows the graphic user interface of the construction system.

FIG. 12 shows the process for designing the U-groove with the construction system.

### DETAILED DESCRIPTION OF THE PREFERRED EMBODIMENTS

The preferred embodiment of the design method is illustrated with the drawings, but not restricts the scope of the present invention. Any design method based on functional features of a structure or achieved by stacking up the functional features should belong to the present invention.

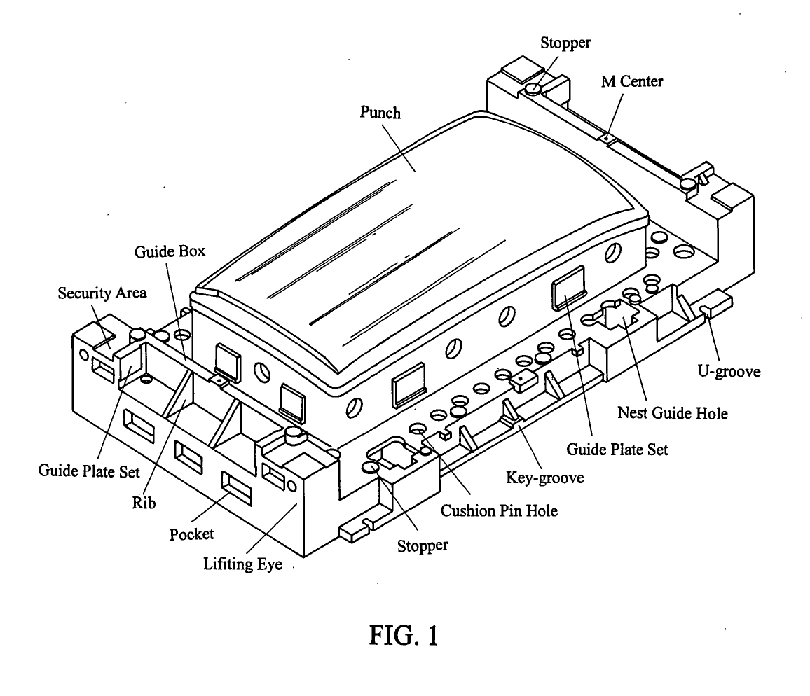

In general, a mechanical structure is designed for a certain purpose. To attain such purpose, assistant functions or extended functions may be required and make the structure more complex. For example, a drawing die for drawing sheet metal to a predetermined shape generally needs additional components for positioning the sheet metal and guiding the sheet metal. FIG. 1 shows some components performing additional functions in a drawing die. If the machine is normally provided with standard structures, methods for designing the machine will be specific and depend on the demands for machining and producing. For example, a stamping press of the stamping die normally owns a feature with the function of fixing the sheet metal, i.e., U-groove. That is, each feature provided in the present invention has to exhibit one or more functions.

To construct an object, the smallest design units, functional features, are first stacked up from the bottom to form functional parts. The functional parts are further combined as a design unit or a sub-design unit. After all, the predetermined structure will be constructed.

The feature-based design approach, also known as design-by-form-feature or feature-based modeling, provides the designer with a feature library wherein sets of form features are used for modeling. The stacking-up design of this invention is based on “functional features” such as hub, rib and hook, which is different from the traditional design based on “form features”, such as pad, pocket and hole. The functional features have to meet requirements as follows:
(i) implying purposes for designing this object;
(ii) having a set of features related to a certain function;
(iii) having non-geometric parameters related to a certain function; and
(iv) capable of exhibiting a certain function.

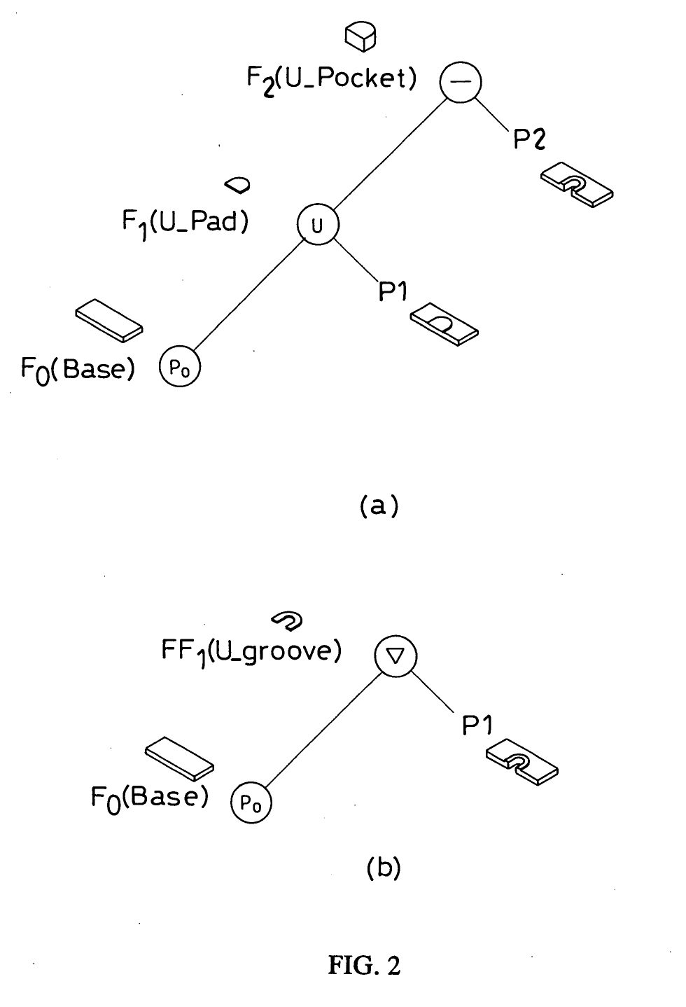

To construct a 3D model with traditional systems, Boolean logic is usually applied. For example, the U-groove shown in FIG. 2(a) may be constructed by first providing a base (F₀), then giving a union (P₁) of U_Pad (F₁) and F₀, and finally giving the U-groove (P₂) by differentiating U_Pocket (F₂) from P₁. Though Boolean logic is also used in the function-based design, however the components or features are combined or stacked up according to relationships of their functions. Therefore, the user can simply load each functional feature into the CAD environment and easily operate them as units for stacking. As shown in FIG. 2(b), the final design (P₁) can be directly obtained from the union of the base (F₀) and the U-groove (functional-featured component, FF₁).

### Reasoning Process for Determining Functional Features

To construct an object, the functional features have to be first determined with a reasoning process in which structure and design options of the object should be clearly identified. The control parameters and relationships therebetween should be also established so as to efficiently stack up the functional features.

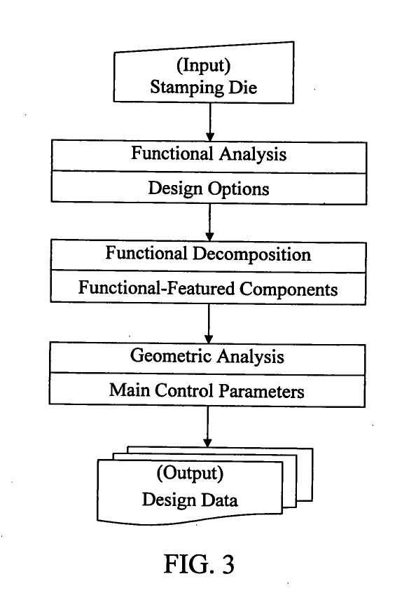

For a stamping die, the reasoning process for determining design options, functional features and their control parameters includes: functional analysis, functional decomposition and geometric analysis. FIG. 3 generally shows the reasoning process and results thereof will be stored in a functional feature library.

### 1. Functional Analysis

For a structure, “task functions” and “sub-functions” such as assistant functions and extended functions have to be defined before determining design options with “function tree”. The “task function” implies the purpose “why” to deign the object; and “sub-functions” implies the capability “how” to achieve the function. For example, the purpose and the capability of the U-groove of a drawing die are respectively “to fix the die” and “to secure the die”.

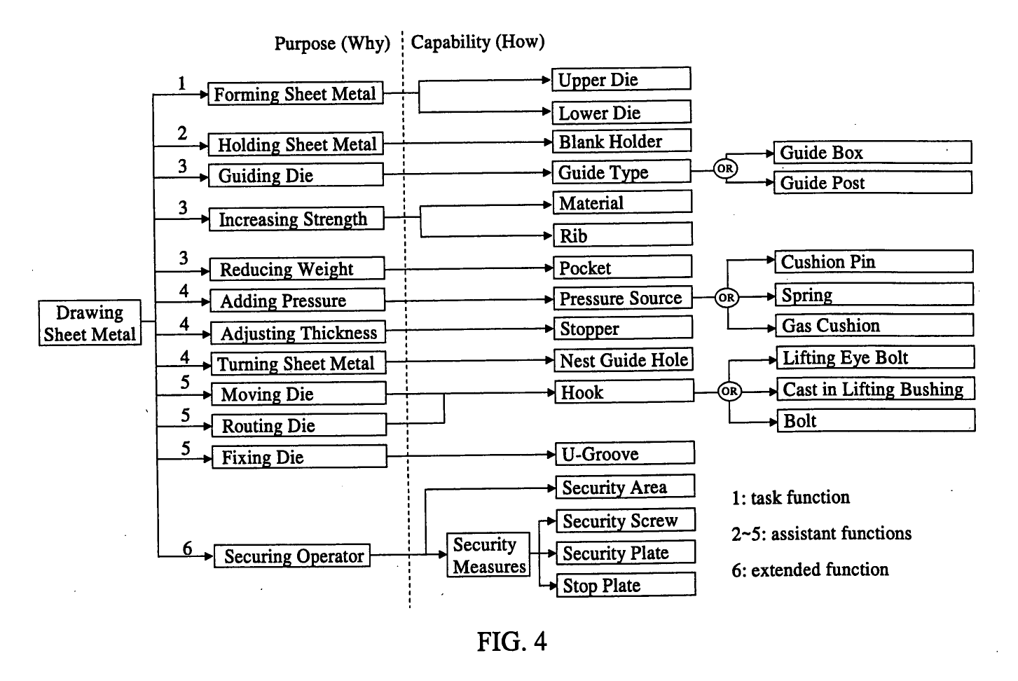

In the functional analysis of a drawing die, “forming sheet metal” is the “task function”. Then all assistant and extended functions are determined by backward searching based on this task function. Next, all available design options can be identified. As shown in FIG. 4, each of the design options includes one or more options. For example, a hook may be provided with three different types: lifting-eye bolt, cast-in-lifting bushing and bolt which are connected with “OR”. Designers can select one of theses types depending on design requirements.

### 2. Functional Decomposition

By means of the above functional analysis, the design options of the drawing die are determined. However, each of the design options represents only a portion of the die and perhaps includes more than one functional feature. For example, the guide box for guiding the die to move in a correct direction in FIG. 1 includes three functional features: a guide plate set, a stopper and a strengthening rib.

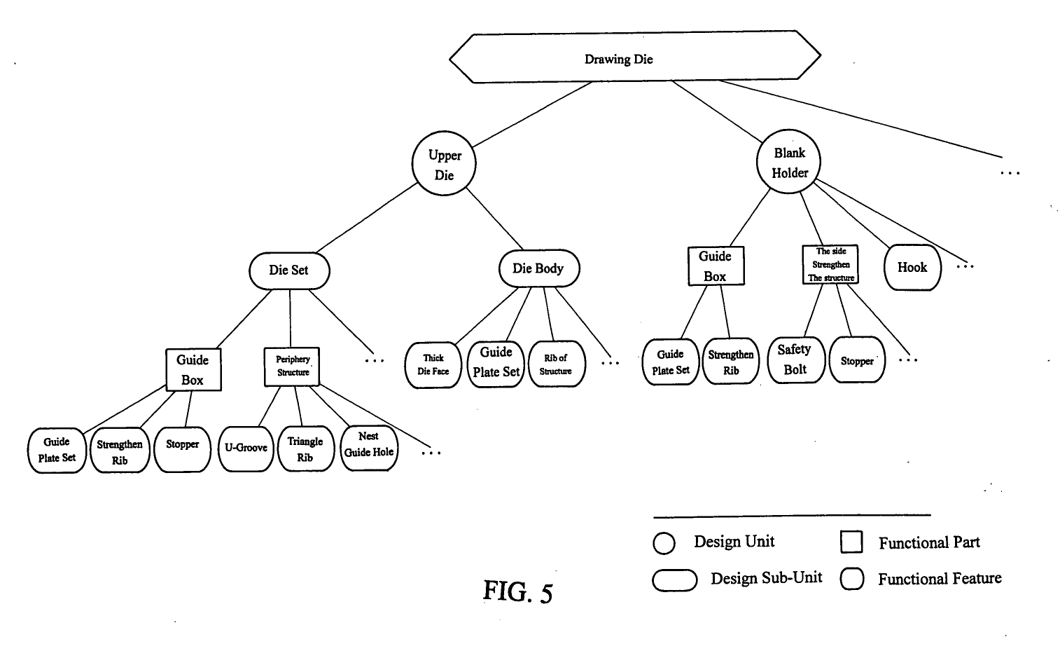

The process for decomposing design options of a drawing die is shown in FIG. 5. Basically, each of the design options can be sorted into one of the four levels: design units, sub-design units, functional parts and functional features. The complex design options will be decomposed with the divide-and-conquer process from the functional point of view until all functional features are found.

### 3. Geometric Analysis

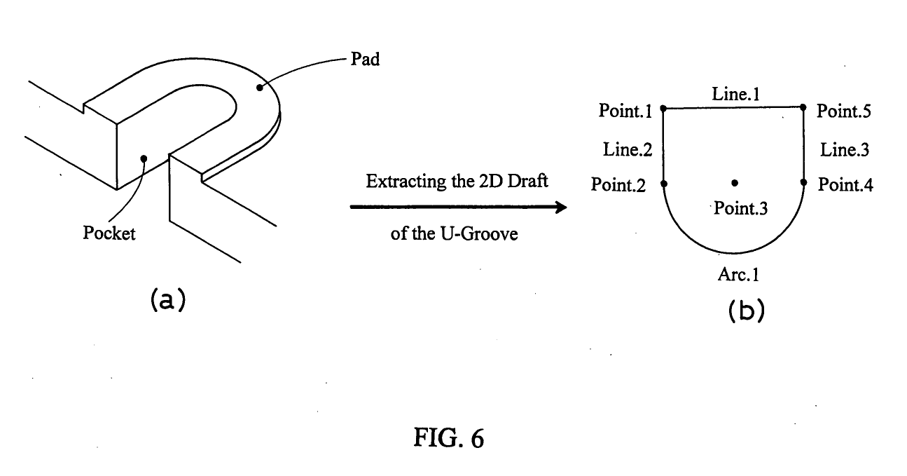

In geometric analysis, geometric entities, geometric constraints and dimension constraints of the functional features are concerned, so that geometric entities can be stably manipulated and the functional features can be easily controlled. In a CAD system, history of the geometric analysis will be extracted to a two-dimension (2D) draft. FIG. 6 shows the 2D draft of the U-groove. The draft is then analyzed through geometric classification, denomination of the parameters, classification of the parameters, geometric relationships and parameter types, so that the control parameters and the relationship among all components can be identified. For the U-groove of the drawing die, the geometric analysis includes:

(i) geometric classification: identifying basic entities, geometry entities, geometric constraints, and dimension constraints in the CAD system;

(ii) denomination of the parameters: denominating the control parameters certain names and other parameters the serial numbers in the CAD system;

(iii) classification of the parameters: classifying the parameters into geometric parameter or position parameters;

(iv) geometric relationship: identifying relationships between all parameters so as to correctly describe and execute a computer program;

(v) parameter types: classifying the parameters into parameters, variables or constants.

The geometric information of the U-groove is listed in Table 1.

TABLE 1

| | | | Parameters | |
|---|---|---|---|---|
| Category | Parameters | Relationship | Classificati | Type |
| Basic | Origin | — | Geometric | Const |
| Entity | H direction | — | Geometric | Const |
| | V direction | — | Geometric | Const |
| Geometric | Point.1 | Line.1, Line.2 | Geometric | Para |
| Entity | Point.2 | Line.2, Arc.1 | Geometric | Para |
| | Point.3 | Arc.1 | Geometric | Para |
| | Point.4 | Arc.1, Line.3 | Geometric | Para |
| | Point.5 | Line.3, Line.1 | Geometric | Para |
| | Line.1 | S: Point.5, E: Point.1 | Geometric | Para |
| | Line.2 | S: Point.1, E: Point.2 | Geometric | Para |
| | Line.3 | S: Point.4, E: Point.5 | Geometric | Para |
| | Arc.1 | Point.3 | Geometric | Para |
| Geometric | Coincidence.1 | Line.1, Input.2 | Position | Para |
| Constraint | Tangency.1 | Line.2, Arc.1 | Position | Para |
| | Tangency.2 | Line.3, Arc.1 | Position | Para |
| | Perpendicular.1 | Line.1, Line.2 | Position | Para |
| | Perpendicular.2 | Line.1, Line.3 | Position | Para |
| Dimension | U-Center | Point.3, Absolute | Position | Varia |
| Constraint | Length.1 | Line.2, Line.3 | Position | Varia |
| | Radius.1 | Arc.1 | Position | Varia |

In Table 1, “U-Center” is a control parameter for the U-groove as shapes and dimensions of the U-groove will vary with the U-Center. The most important for geometric analysis is to identify a non-geometric parameter having a function similar to the U-Center, whereby the functional features can be stably controlled in the CAD system.

### System for Implementing the Method

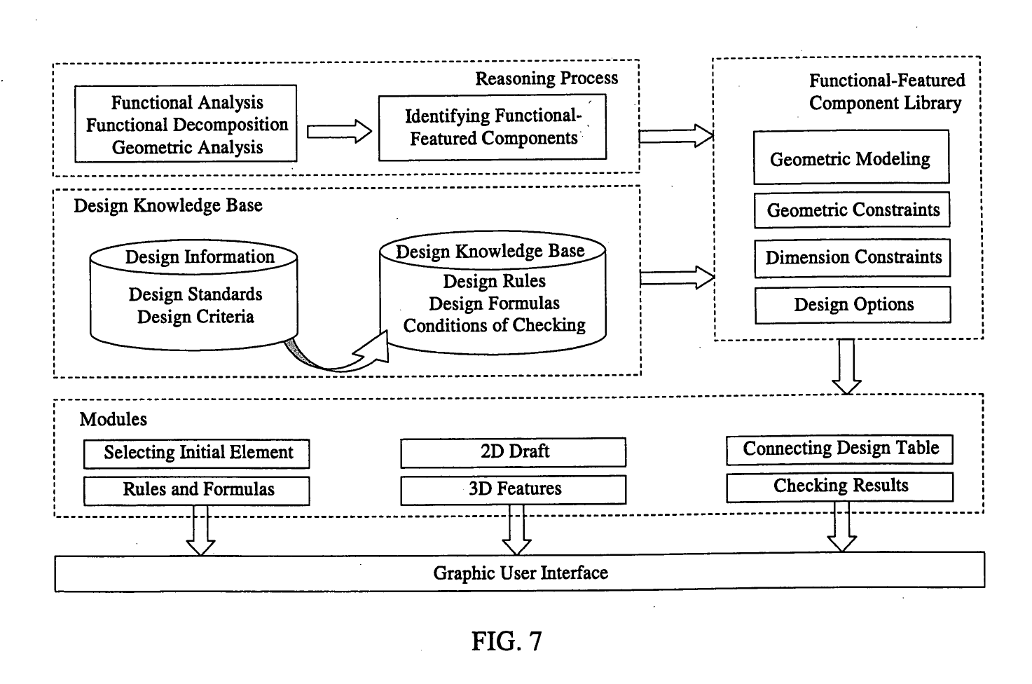

To implement the method for constructing an object by stacking up functional features, a construction system of the drawing die is exemplified and developed. FIG. 7 shows a process of this construction system which includes a design knowledge base, a functional feature library, functional-feature modules, and graphic user interfaces. This system uses CATIA V5 as the CAD environment, MS Visual Basic 6.0 as the system language and CAA V5 Automation API to interact with CATIA. The system is suitable for personal computers.

### 1. Design Knowledge Base

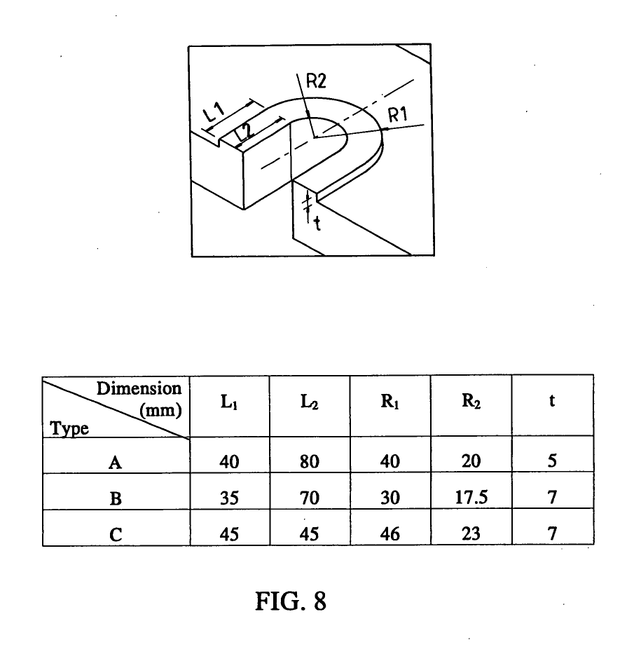

To facilitate the CAD system to fast and easily utilize design data, the design data in the knowledge base are converted to a format compatible with the computer system. FIG. 8 shows design standard of the U-groove with a cross-referring table.

The design data in the knowledge base are previously processed systematically based on each of the functional features obtained in the above reasoning process. By mapping the design standards and design criteria with each functional feature, the design data for each functional feature will be available for design.

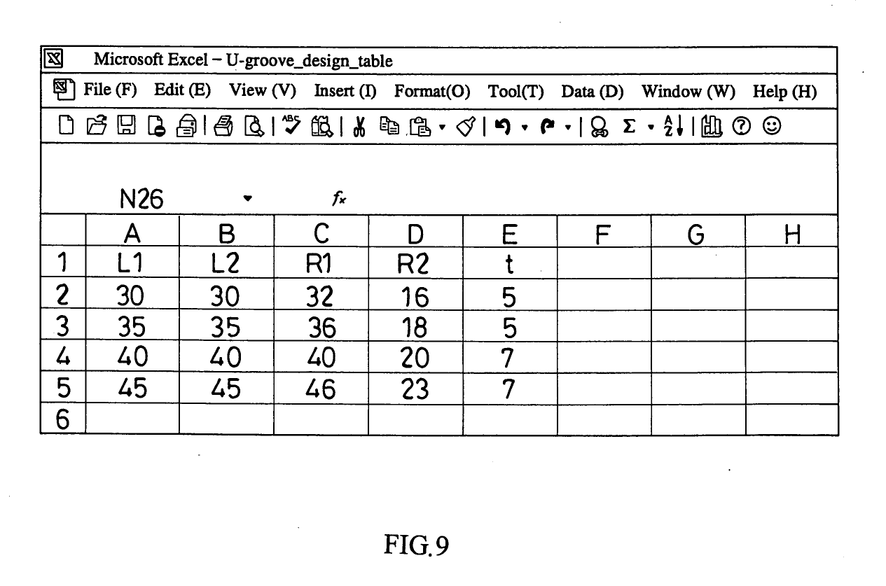

In this embodiment, conversion of the design data includes: a) converting the design standards into design tables; and b) converting design criteria into design rules, formulae and conditions for checking construction results which can be used to constrain dimensions, calculate positions of the functional features and check the design. The process b) can be achieved with a grammatical approach. Since CATIA can be connected to MS Excel, all dimension parameters are transferred into an Excel worksheet where the desired dimension data for design can be retrieved from. FIG. 9 shows the Excel worksheet.

### 2. Functional Feature Library

As dimensions of the U-groove strictly vary with weight of the die, the design tables are read simultaneously while the functional feature library is used. Accordingly, the functional features can be standardized.

The functional feature library is built by sorting the functional features obtained in the above reasoning process into respective categories based on their functional characteristics. For each sorted functional feature, the design data including a design table, design rules, design formulas and conditions for checking construction results are input into its module based on the dimension, position, and control parameters of a model so as to build the knowledge base. Design information in the knowledge base can be fast and easily selected for constructing a die based on the functional features.

### 3. Functional Feature Modules

In the functional feature modules, the functional feature library and the knowledge base are integrated. Each module includes sub-modules for constructing a model, connecting the design tables, establishing rules and formulas, and checking the construction results.

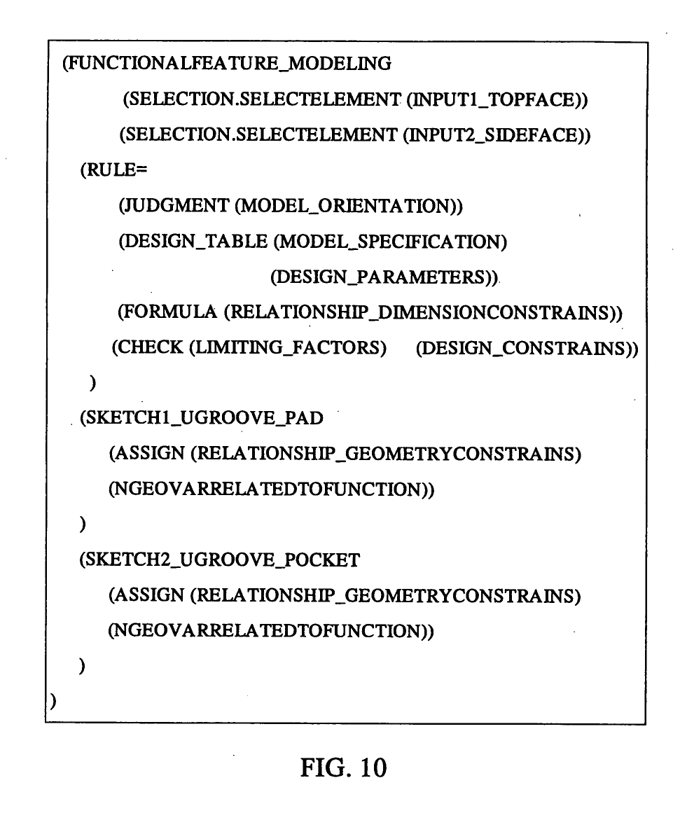

In the sub-module for constructing model, shapes of the functional feature s can be formed through initial information construction, 2D draft construction and 3D feature construction. In the sub-module for connecting design tables, the parameters of the model can be retrieved from cells of the Excel worksheets. In these sub-modules, design rules, formulas and conditions for checking results can be established so as to correctly construct the model. FIG. 10 shows the code of modules for constructing the U-groove.

### 4. Graphic User Interface

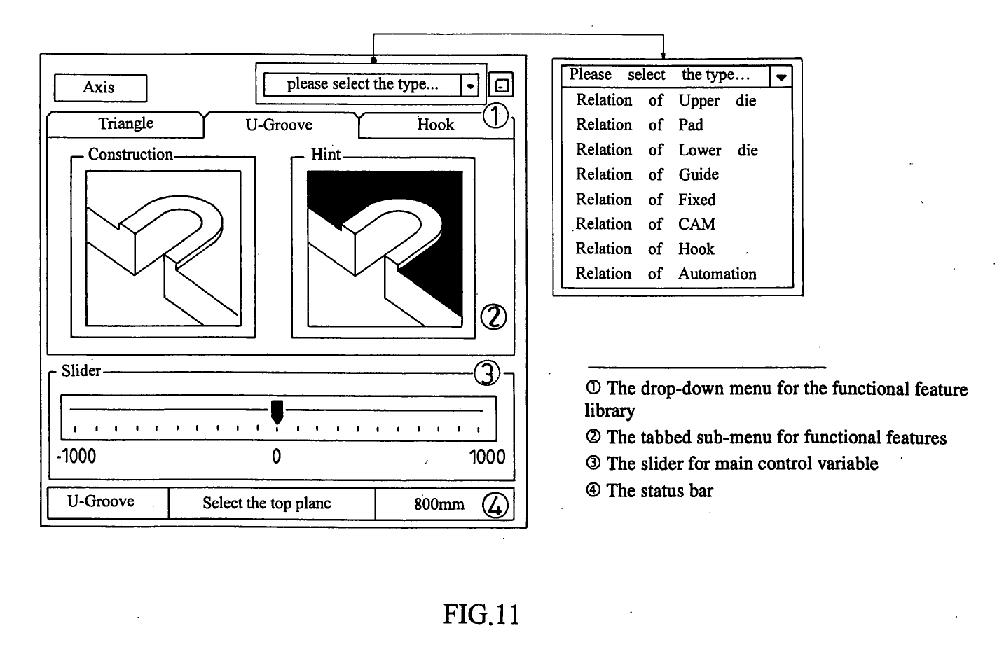

As shown in FIG. 11, the graphic user interface shows a drop-down menu including the categories in the functional feature library, a tabbed sub-menu including functional features, a slider window for tuning the parameters, and a status bar.

Since the drawing die has a complex structure, the functional features thereof have to be sorted into distinct categories in the functional feature library. As shown in FIG. 11, the categories are listed in the drop-down menu. The user may select a category to introduce a lower tabbed submenu including the corresponding functional features.

In the preferred embodiment of FIG. 11, hints about how to operate next will be shown on the right screen after the user selects a functional feature shown on the left screen. When the functional feature is selected, values of the control parameters and the position of the functional feature can be tuned on a slider window. Meanwhile, the position of the functional feature with respect to the coordinate center will be displayed on the status bar so that the user can fine tune the control parameters to correct values.

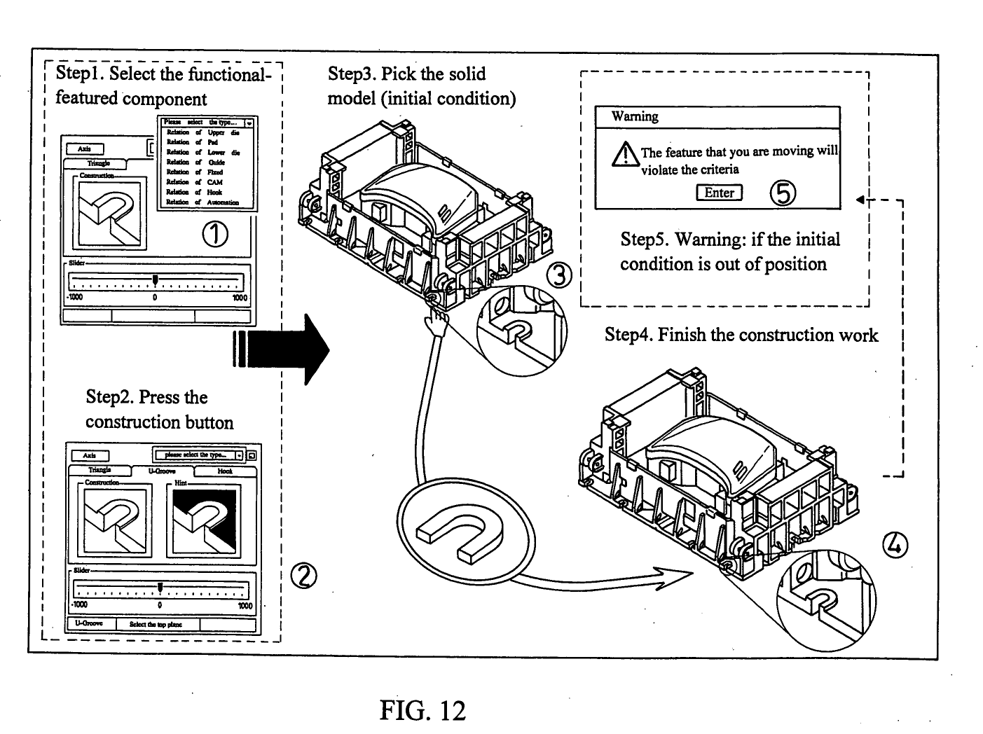

FIG. 12 shows serial screens of the CATIA 3D CAD system, on which a U-groove of the drawing die in an engine hood is constructed through Steps 1-4 (or 5), and the functional feature s including a hook is stacked up.

First, in the CATIA 3D CAD system, the 3D model of the drawing die to be design is loaded. The construction system then loads a window which allows the user to choose the functional features After that, the user chooses the relation of fixed die for functional feature that are to be stacked up, such as U-groove, as shown in step 1. When the construct button of U-groove is pressed, a prompt will be displayed to the right of the button, which reminds the user that he needs to assign the position to conduct the functional feature, as shown in step 2. Next, the user picks the approximate position where the U-groove will be constructed, as shown in step 3. When all of the aforementioned selections are made, the system then converts these selections into data, which also serve as the initial conditions. Next, the system begins to construct the functional feature based on the position, dimension, and quantity, as shown in step 4. Once the system finishes constructing the functional feature, a window showing a warning message pops up if the insertion position of the functional feature contradicts with the design criteria, as shown in step 5. The warning message lists the states that the functional feature violates.

In general, efficiency of constructing a die with a CAD system varies with automation degree thereof. The present invention promotes automation of the system by providing a graphic user interface. The present invention also simplifies procedures of system operation by, for example, selecting the functional features from a menu with sorted categories. In addition, positions of the functional features can be easily determined by moving a mouse without previously inputting geometric conditions such as points, lines and surfaces.

In the present invention, the reasoning process utilizing functional analysis, functional decomposition and geometric analysis facilitates determination of the functional features and the control parameters.

To provide accurate designs, the system of the present invention can automatically check the construction results according to the design criteria. Moreover, the system provides a slider window on the graphic user interface so that control parameters and positions of the functional features can be fine tuned.

It should be noticed that, in addition to the CATIA system, other systems suitable for the present invention also can be applied to stacking up functional features and constructing a model.

What is claimed is:

1. A method for constructing an object, comprising a step of:
stacking up functional features of the object to obtain one functional-featured part or a plurality of functional-featured parts;
if one functional-featured part, the object is constructed;
if a plurality of functional-featured parts, the method further comprising a step of:
stacking up the functional-featured parts to obtain one or more design units.

2. The method as claimed in claim 1, wherein the functional features are sequentially stacked up from a bottom of the object.

3. The method as claimed in claim 1, wherein the functional features are identified through functional analysis, functional decomposition and geometric analysis, and meanwhile their control parameters for design are determined.

4. The method as claimed in claim 3, wherein the functional analysis is to find the design options and performed with a function tree algorithm from a functional point of view, in which the functions are classified into task functions and sub-functions including assistant functions and extended functions.

5. The method as claimed in claim 3, wherein the functional decomposition is to decompose the object into small structures each of which is then sorted into one of four levels including design units, sub-design units, functional parts and functional features.

6. The method as claimed in claim 3, wherein the geometric analysis is to identify the main control parameters by determining geometric categories, denominating the parameters, classifying the parameters, establishing geometric relationships between the parameters and determining types of the parameters through a computer aided construction system.

7. The method as claimed in claim 3, which is implemented on a Windows platform by applying a commercialized computer aid design software, an application programming interface and a program language through a design knowledge base, a functional feature library, a functional feature module and a graphic user interface.

8. The method as claimed in claim 7, wherein the design knowledge base includes:
design standards of the object which is converted into a design table; and
design criteria of the object which is converted into rules, formulae and conditions for determining and checking construction results,
accordingly, positions and dimensions of the functional features can be determined and checked.

9. The method as claimed in claim 7, wherein the functional feature library comprises a plurality of categories of the functional features which are classified according to their functional characteristics;
wherein each of the classified functional features is input into a module according to practical dimensions, positions and main control parameters with the design table, the design criteria, the design formulae and conditions for checking results; and
accordingly, the functional features can be rapidly selected from the functional feature library and designed.

10. The method as claimed in claim 7, wherein the functional feature module is constructed by integrating the functional feature library and the design knowledge base; and each module comprises sub-modules for constructing a model, connecting the design tables, establishing rules and formulas, and checking construction result.

11. The method as claimed in claim 10, wherein the module is constructed sequentially by building initial information, making a 2D draft and constructing a 3D module.

12. The method as claimed in claim 10, wherein the sub-module for constructing a model further comprises design rules, formulas and conditions for checking results.

13. The method as claimed in claim 7, wherein the graphic user interface comprises a drop-down menu of the functional feature library, a tabbed sub-menu of functional features, a slider window for tuning parameters, and a status bar.

14. A system for constructing an object, comprising:
a design knowledge base providing information how to design the object by stacking up functional features thereof;
a functional feature library comprising the functional features of the object wherein the components are classified according to their functional characteristics;
a functional feature module constructed by integrating the design knowledge base and the functional feature library; and
a graphic user interface for users to operate the system;
accordingly, the system can be implemented through a commercial computer aid design software, an application programming interface and a program langue.

15. The system as claimed in claim 14, wherein the functional feature library comprises a plurality of categories of the functional features which are classified according to their functional characteristics; and each of the classified functional features is input into a module according to practical dimensions, positions and main control parameters with the design table, the design criteria, the design formulae and conditions for verification; and accordingly the functional features can be rapidly selected from the functional feature library and designed according to the design knowledge base.

16. The system as claimed in claim 14, wherein the functional feature module is constructed by integrating the functional feature library and the design knowledge base; and each module comprises sub-modules for constructing a model, connecting the design tables, establishing rules, formulas, and conditions, and checking construction results.

17. The system as claimed in claim 16, wherein the module is constructed sequentially by building initial information, making a 2D draft and constructing a 3D module.

18. The system as claimed in claim 16, wherein the sub-module for constructing a model further comprises design rules, formulas and conditions for checking construction results.

19. The system as claimed in claim 14, wherein the graphic user interface comprises a drop-down menu of the functional feature library, a tabbed sub-menu of functional features, a slider window for tuning the parameters, and a status bar.
